(19) United States
(12) Patent Application Publication
(10) Pub. No.: US 2010/0019027 A1
(43) Pub. Date: Jan. 28, 2010

(54) Methods of processing a last check of a bunch of checks deposited at a self-service terminal during a bunch-check deposit transaction

(75) Inventors: Brian P. Connell, waterloo (CA); Gary R. Marshall, Waterloo (CA)

Correspondence Address: MICHAEL CHAN;NCR CORPORATION, 1700 SOUTH PATTERSON BLVD, DAYTON, OH, 45479-0001, US

(73) Assignee: NRC Corporation

(21) Appl. No.: 12/220,149

(22) Filed: Jul. 22, 2008

(51) Int. Cl. G07D 11/00

(52) U.S. Cl. 235/379

(57) ABSTRACT

A method is provided of processing a last check of a bunch of checks deposited at the self-service terminal during a bunch-check deposit transaction. The method comprises receiving the last check along a check transport path, processing the last check as the last check is being transported along the check transport path, transporting the processed check to a virtual escrow which is along a portion of the check transport path and which is other than a physical escrow, approving the bunch-check deposit transaction as the last check is being held in the virtual escrow, after the bunch-check deposit transaction is approved, transporting the last check from the virtual escrow to an endorser to allow the endorser to endorse the last check, endorsing the last check, and after the last check is endorsed, transporting the endorsed check to a storage bin.

### BACKGROUND

The present invention relates to self-service check depositing transactions, and is particularly directed to methods of processing a last check of a bunch of checks deposited at a self-service terminal, such as a check depositing automated teller machine (ATM), during a bunch-check deposit transaction.

In a typical check depositing ATM, an ATM customer is allowed to deposit a check (without having to place the check in any deposit envelope) in a publicly accessible, unattended environment. To deposit a check, the ATM customer inserts a user identification card through a user card slot at the ATM, enters the amount of the check being deposited, and inserts the check to be deposited through a check slot of a check acceptor. A check transport mechanism receives the inserted check and transports the check in a forward direction along a check transport path to a number of locations within the ATM to process the check.

If the check is not accepted for deposit, the check transport mechanism transports the check in a reverse direction along the check transport path to return the check to the ATM customer via the check slot. If the check is accepted for deposit, the amount of the check is deposited into the ATM customer's account and the check is transported to a storage bin within the ATM. An endorser printer prints an endorsement onto the check as the check is being transported to and stored in the storage bin. Checks in the storage bin within the ATM are periodically picked up and physically transported via courier to a back office facility of a financial institution for further processing.

In some known check depositing ATMs, certain components are housed in modular units which, in turn, are housed in a larger module. The larger module is sometimes referred to as a “check processing module” (CPM). Such modules are included in ATMs provided by NCR Corporation, located in Dayton, Ohio. One example is Model No. CPM2 in which a modular unit called a “pocket module” is located in approximately the rear central portion of the CPM. Another example is Model No. CPM3 in which the pocket module is located in approximately the bottom portion of the CPM. Still another example is Model No. CPM4 in which the pocket module is located in approximately the top portion of the CPM.

Also, in some known check depositing ATMs, the check acceptor may be of the type which allows the ATM customer to deposit more than one check in a single transaction. This type of check acceptor is sometimes referred to as “a bunch-check acceptor”. Also, this type of check deposit transaction is sometimes referred to as “a bunch-check deposit transaction”.

When a bunch-check acceptor is used, the CPM typically includes a physical escrow which collects checks as the checks are transported one-by-one through the bunch-check acceptor and then processed through the CPM. If the bunch-check deposit transaction is approved, then each check collected in the physical escrow is transported one-by-one to the endorser for endorsement. Each endorsed check is transported to the storage bin. If the bunch-check deposit transaction is not approved, then each check collected in the physical escrow is transported to a re-buncher to bunch the checks before returning the bunch of checks back to the ATM customer.

A drawback in using a physical escrow is that it does take time for each deposited check to collect in the physical escrow during the bunch-check deposit transaction. It would be desirable to provide methods of operating the CPM so as to reduce the amount of time needed to process checks which have been deposited in a bunch-check deposit transaction at the check depositing ATM.

### SUMMARY

In accordance with an embodiment of the present invention, a method is provided of processing a last check of a bunch of checks deposited at the self-service terminal during a bunch-check deposit transaction. The method comprises receiving the last check along a check transport path, processing the last check as the last check is being transported along the check transport path, transporting the processed check to a virtual escrow which is along a portion of the check transport path and which is other than a physical escrow, approving the bunch-check deposit transaction as the last check is being held in the virtual escrow, after the bunch-check deposit transaction is approved, transporting the last check from the virtual escrow to an endorser to allow the endorser to endorse the last check, endorsing the last check, and after the last check is endorsed, transporting the endorsed check to a storage bin.

### BRIEF DESCRIPTION OF THE DRAWINGS

In the accompanying drawings:

FIG. 1 is a left-front perspective view of one type of check depositing automated teller machine (ATM) embodying the present invention;

FIG. 2 is a simplified schematic diagram, looking approximately in the direction of arrow A in FIG. 1, and illustrating a check processing module (CPM) configured to operate in the ATM of FIG. 1;

FIG. 3 is diagram similar to the diagram of FIG. 2, and illustrating the CPM configured to operate in another type of ATM;

FIG. 4 is diagram similar to the diagrams of FIGS. 2 and 3, and illustrating the CPM configured to operate in yet another type of ATM;

FIG. 5 is a pictorial view of a transport module of the CPM of FIG. 2;

FIG. 6 is a flowchart depicting operation of the CPM of FIG. 4 in accordance with one embodiment of the present invention;

FIG. 7 is a diagram similar to FIG. 2, and showing additional details and one check in physical escrow;

FIG. 8 is a diagram similar to FIG. 7, and showing the one check in physical escrow and another check in virtual escrow in accordance with the flowchart of FIG. 6;

FIG. 9-12 are diagrams similar to FIG. 8, and showing the two checks in different positions; and

FIGS. 13-15 are diagrams similar to FIGS. 7-12, and showing only one check which is deposited and processed in accordance with the flowchart of FIG. 6.

### DETAILED DESCRIPTION

The present invention is directed to methods of processing a last check of a bunch of checks deposited at the self-service terminal during a bunch-check deposit transaction.

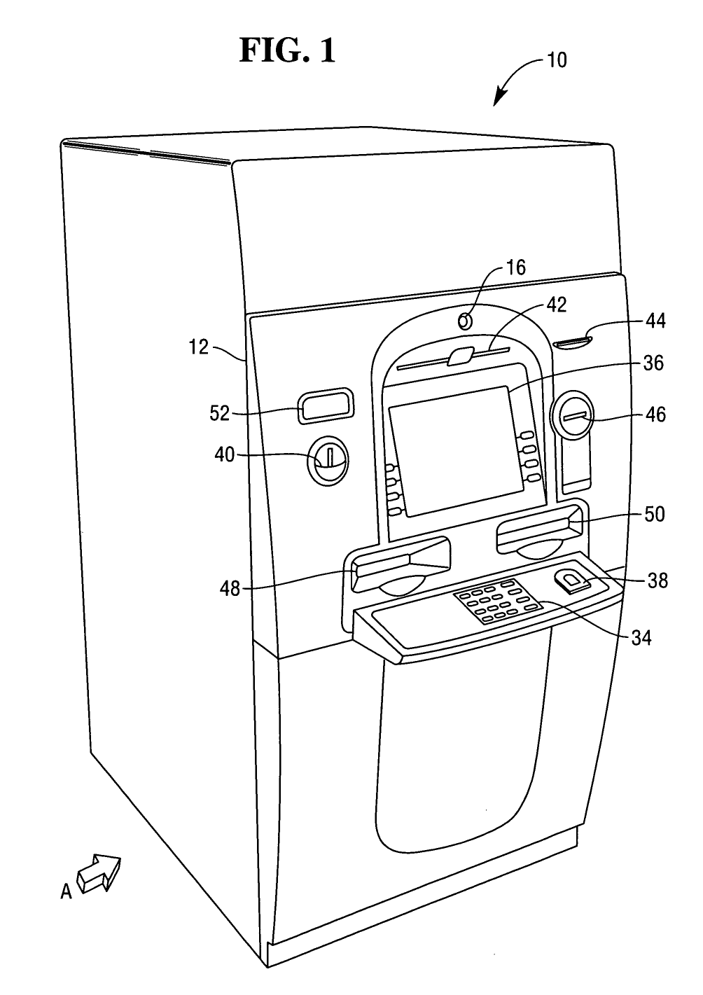

Referring to FIG. 1, a self-service check depositing terminal in the form of an image-based check depositing automated teller machine (ATM) 10 is illustrated. The check depositing ATM 10 comprises a fascia 12 coupled to a chassis (not shown). The fascia 12 defines an aperture 16 through which a camera (not shown) images a customer of the ATM 10. The fascia 12 also defines a number of slots for receiving and dispensing media items, and a tray 40 into which coins can be dispensed. The slots include a statement output slot 42, a receipt slot 44, a card reader slot 46, a cash slot 48, another cash slot 50, and a check input/output slot 52. The slots 42 to 52 and tray 40 are arranged such that the slots and tray align with corresponding ATM modules mounted within the chassis of the ATM 10.

The fascia 12 provides a user interface for allowing an ATM customer to execute a transaction. The fascia 12 includes an encrypting keyboard 34 for allowing an ATM customer to enter transaction details. A display 36 is provided for presenting screens to an ATM customer. A fingerprint reader 38 is provided for reading a fingerprint of an ATM customer to identify the ATM customer. The user interface features described above are all provided on an NCR PERSONAS (trademark) 6676 ATM, available from NCR Financial Solutions Group Limited, Discovery Centre, 3 Fulton Road, Dundee, DD2 4SW, Scotland.

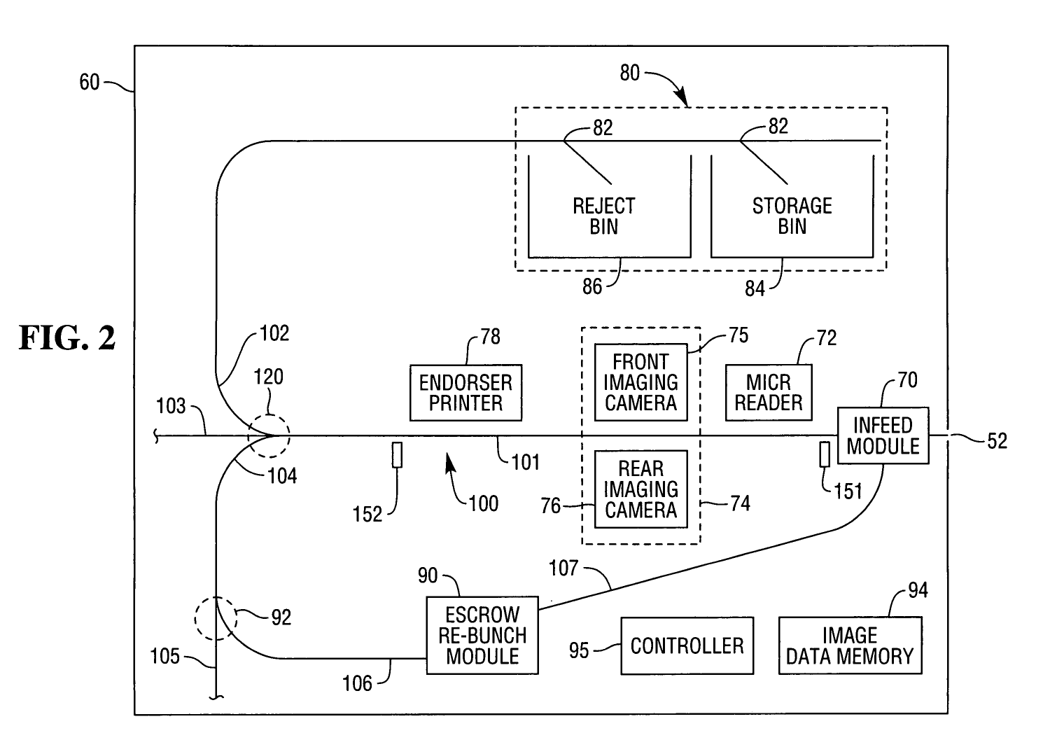

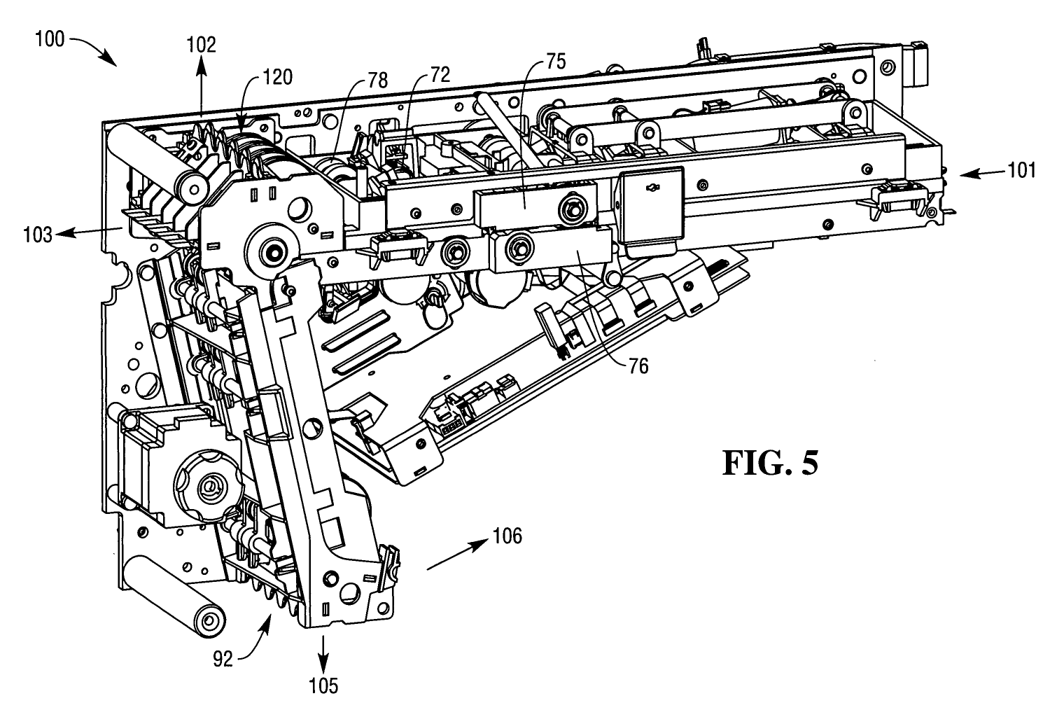

Referring to FIG. 2, a first configuration of a check processing module (CPM) 60 is illustrated. The CPM 60 will now be described with reference to FIGS. 2 and 5. FIG. 2 is a simplified schematic diagram (looking approximately in the direction of arrow A in FIG. 1) of part of the fascia 12 and main parts of the CPM 60. FIG. 5 is a pictorial view of a part (to be described later) used in the CPM 60 shown in FIG. 2.

The CPM 60 of FIG. 2 comprises four main units which include an infeed module 70, a pocket module 80, an escrow re-bunch module (ERBM) 90, and a transport module 100. The infeed module 70 receives a check which has been deposited into the check input/output slot 52. (FIG. 1), and transports the check to an inlet of the transport module 100. The dimensions of the infeed module 70, such as its run length, may vary depending upon the particular model ATM the CPM 60 is installed. The structure and operation of the infeed module 70 are conventional and well known and, therefore, will not be described.

The transport module 100 (also shown in FIG. 5) includes a check input/output transport mechanism which receives a check from the inlet adjacent to the infeed module 70, and transports the check along a first document track portion 101 which is the main track portion. The transport module 100 includes a first document diverter 120 which is operable to divert a check along a second document track portion 102 to the pocket module 80, a third document track portion 103 (not used in the configuration shown in FIG. 2), or a fourth document track portion 104 which leads to the ERBM 90.

The structure and operation of the first diverter 120 shown in FIG. 2 may be any suitable diverter which is capable of diverting a check along one of three different document transport paths. An example of a suitable three-way diverter is disclosed in U.S. patent application Ser. No. 12/004,354, filed on Dec. 20, 2007, entitled “Document Diverter Apparatus for Use in a Check Processing Module of a Self-Service Check Depositing Terminal”, and assigned to NCR Corporation located in Dayton, Ohio. The disclosure of U.S. patent application Ser. No. 12/004,354 is hereby incorporated by reference.

A second document diverter 92 is operable to divert a check along a fifth document track portion 105 (not used in the configuration shown in FIG. 2), or a sixth document track portion 106 which leads to the ERBM 90. A seventh document track portion 107 interconnects the ERBM 90 and the infeed module 70. More specifically, the seventh document track 107 interconnecting the ERBM 90 and the infeed module 70 allows a bunch of checks which has accumulated in the ERBM to be transported back to the infeed module 70. The structure and operation of the second diverter 92 are conventional and well known and, therefore, will not be described.

The transport module 100 further includes a magnetic ink character recognition (MICR) head 72 for reading magnetic details on a code line of a check. The transport module 100 also includes an imager 74 including a front imaging camera 75 and a rear imaging camera 76 for capturing an image of each side of a check (front and rear). An endorser printer 78 is provided for printing endorsements onto checks. An image data memory 94 is provided for storing images of checks. A controller 95 is provided for controlling the operation of the elements within the CPM 60. A first sensor 151 is disposed along the first document track portion 101 just before the MICR head 72. A second sensor 152 is disposed along the first document track portion 101 just after the endorser printer 78.

The pocket module 80 includes a main storage bin 84 for storing processed checks. The pocket module 80 further includes a reject bin 86 for storing rejected checks. A divert gate 82 is provided for diverting checks to the reject bin 86. If the checks are not diverted to the reject bin 86, they will continue on to the main storage bin 84. The structure and operation of the pocket module 80 are conventional and well known and, therefore, will not be described.

It should be apparent that the CPM 60 of FIG. 2 is shown in a first configuration where a pocket module is located in a top portion of the CPM. Accordingly, components of the CPM 60 of FIG. 2 are configured in a first mode of operation to provide functionality of the Model CPM4 check processing module sold by NCR Corporation.

The CPM 60 is of the type which is capable of processing a bunch of checks. When a bunch of checks is being processed, each check of the bunch is separated at the infeed module 70 before it is individually processed. Each processed check is then re-assembled at the ERBM 90 to bunch the checks back together. This type of processing is sometimes referred to as “multiple-check processing”. Since individual checks are being bunched back together, an escrow re-bunch module (such as the ERBM 90 shown in FIG. 2) is needed. The ERBM 90 is manufactured and available from Glory Products, located in Himeji, Japan.

The ERBM 90 allows a bunch of checks (i.e., more than one check) to be processed in a single transaction. If a bunch of checks has accumulated in the ERBM 90 and is unable to be processed further within the CPM 60, then the bunch of checks is transported via the seventh document track portion 107 back to the infeed module 70 to return the bunch of checks to the ATM customer. The structure and operation of the ERBM 90 will be described in more detail later.

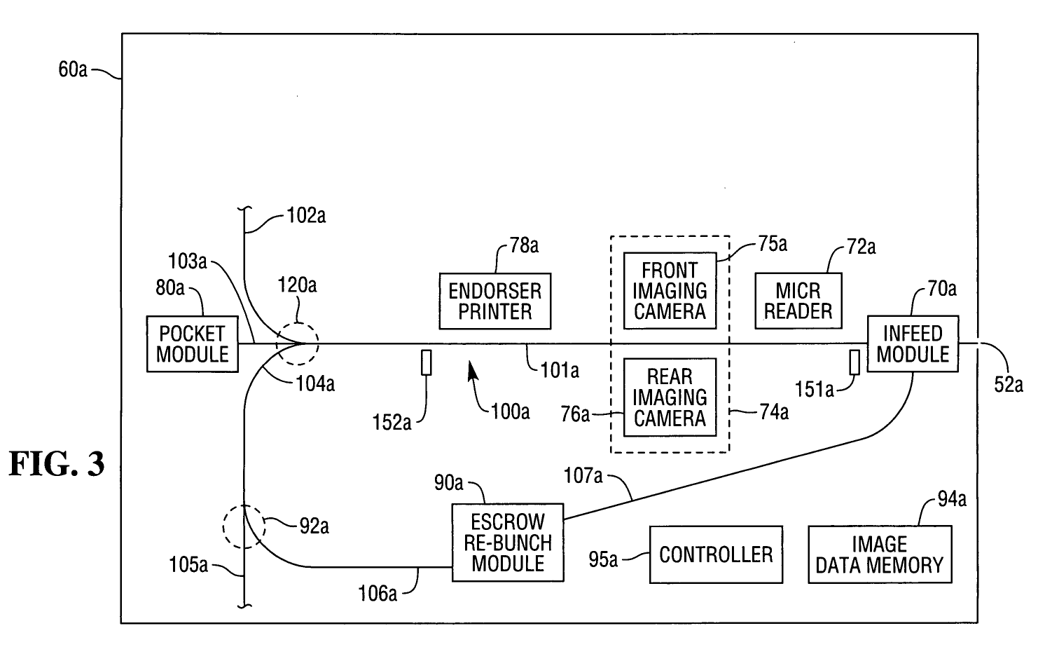

Referring to FIG. 3, a second configuration of the CPM 60 of FIG. 2 is illustrated. Since the configuration illustrated in FIG. 3 is generally similar to the configuration illustrated in FIG. 2, similar numerals are utilized to designate similar components, the suffix letter “a” being associated with the configuration of FIG. 3 to avoid confusion.

The CPM 60a shown in FIG. 3 is in a configuration where the pocket module 80a is located in a rear portion of the CPM. Accordingly, components of the CPM 60a shown in FIG. 3 are configured in a second mode of operation to provide functionality of the Model CPM2 check processing module sold by NCR Corporation.

The CPM 60a shown in FIG. 3 comprises four main units which include the infeed module 70a, the pocket module 80a, the ERBM 90a, and the transport module 100a. The infeed module 70a receives a check which has been deposited into the check input/output slot 52a, and transports the check to an inlet of the transport module 100a. The dimensions of the infeed module 70a, such as its run length, may vary depending upon the particular model ATM the CPM 60a is installed. The structure and operation of the infeed module 70a are conventional and well known and, therefore, will not be described.

The transport module 100a includes a check input/output transport mechanism which receives a check from the inlet adjacent to the infeed module 70a, and transports the check along the first document track portion 101a which is the main track portion. The transport module 100a includes the first document diverter 120a which is operable to divert a check along the second document track portion 102a (not used in the configuration shown in FIG. 3), the third document track portion 103a to the pocket module 80a, or the fourth document track portion 104a which leads to the ERBM 90a.

The second document diverter 92a is operable to divert a check along the fifth document track portion 105a (not used in the configuration shown in FIG. 3), or the sixth document track portion 106a which leads to the ERBM 90a. The seventh document track portion 107a interconnects the ERBM 90a and the infeed module 70a. More specifically, the seventh document track 107a interconnecting the ERBM 90a and the infeed module 70a allows a bunch of checks which has accumulated in the ERBM 90a to be transported from the ERBM back to the infeed module 70a. The structure and operation of the second diverter 92a are conventional and well known and, therefore, will not be described.

The transport module 100a further includes a magnetic ink character recognition (MICR) head 72a for reading magnetic details on a code line of a check. The transport module 100a also includes an imager 74a including a front imaging camera 75a and a rear imaging camera 76a for capturing an image of each side of a check (front and rear). An endorser printer 78a is provided for printing endorsements onto checks. An image data memory 94a is provided for storing images of checks. A controller 95a is provided for controlling the operation of the elements within the CPM 60a. A first sensor 151a is disposed along the first document track portion 101a just before the MICR head 72a. A second sensor 152a is disposed along the first document track portion 101a just after the endorser printer 78a.

It should be apparent that the CPM 60a of FIG. 3 is shown in a second configuration where a pocket module (designated with reference numeral “80a” in FIG. 3) is located in a rear central portion of the CPM. Accordingly, components of the CPM 60a of FIG. 3 are configured in a second mode of operation to provide functionality of the Model CPM2 check processing module sold by NCR Corporation.

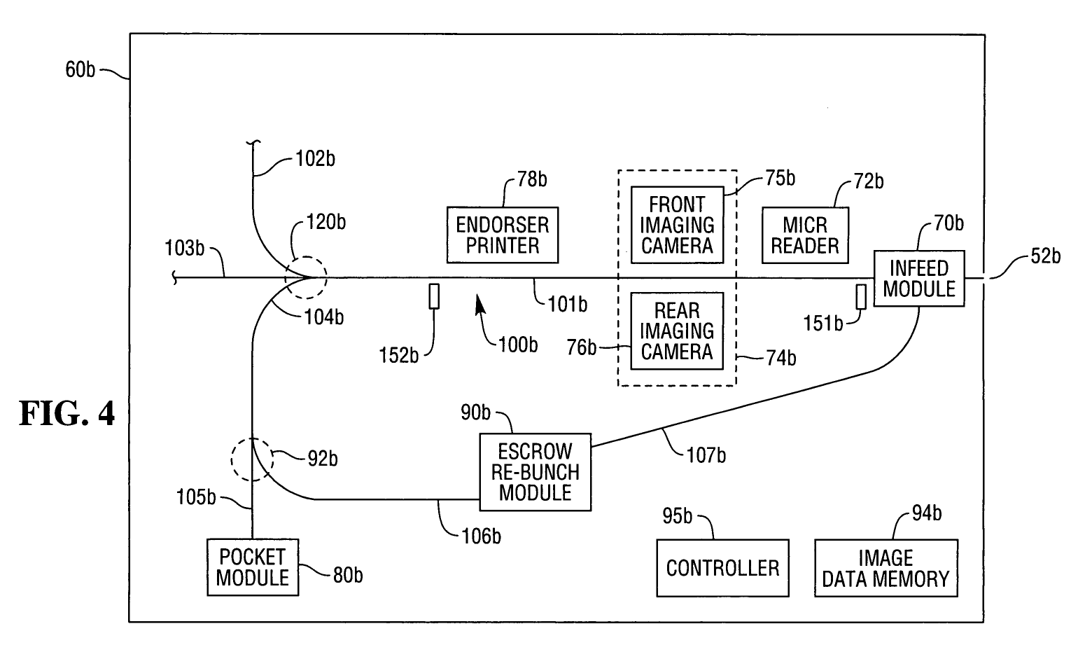

Referring to FIG. 4, a third configuration of the CPM 60 of FIG. 2 is illustrated. Since the configuration illustrated in FIG. 4 is generally similar to the configuration illustrated in FIG. 2, similar numerals are utilized to designate similar components, the suffix letter “b” being associated with the configuration of FIG. 4 to avoid confusion.

The CPM 60b shown in FIG. 4 is in a configuration where the pocket module 80b is located in a bottom portion of the CPM. Accordingly, components of the CPM 60b shown in FIG. 4 are configured in a third mode of operation to provide functionality of the Model CPM3 check processing module sold by NCR Corporation.

The CPM 60b shown in FIG. 4 comprises four main units which include the infeed module 70b, the pocket module 80b, the ERBM 90b, and the transport module 100b. The infeed module 70b receives a check which has been deposited into the check input/output slot 52b, and transports the check to an inlet of the transport module 100b. The dimensions of the infeed module 70b, such as its run length, may vary depending upon the particular model ATM the CPM 60b is installed. The structure and operation of the infeed module 70b are conventional and well known and, therefore, will not be described.

The transport module 100b includes a check input/output transport mechanism which receives a check from the inlet adjacent to the infeed module 70b, and transports the check along the first document track portion 101b which is the main track portion. The transport module 100b includes the first document diverter 120b which is operable to divert a check along the second document track portion 102b (not used in the configuration shown in FIG. 4), the third document track portion 103b (also not used in the configuration shown in FIG. 4), or the fourth document track portion 104b which leads to either the pocket module 80b or the ERBM 90b.

More specifically, the second document diverter 92b is operable to divert a check along either the fifth document track portion 105b which leads to the pocket module 80b or the sixth document track portion 106b which leads to the ERBM 90b. The seventh document track portion 107b interconnects the ERBM 90b and the infeed module 70b. The seventh document track 107b interconnecting the ERBM 90b and the infeed module 70b allows a bunch of checks which has accumulated in the ERBM 90b to be transported from the ERBM back to the infeed module 70b. The structure and operation of the second diverter 92b are conventional and well known and, therefore, will not be described.

The transport module 100b further includes a magnetic ink character recognition (MICR) head 72b for reading magnetic details on a code line of a check. The transport module 100b also includes an imager 74b including a front imaging camera 75b and a rear imaging camera 76b for capturing an image of each side of a check (front and rear). An endorser printer 78b is provided for printing endorsements onto checks. An image data memory 94b is provided for storing images of checks. A controller 95b is provided for controlling the operation of the elements within the CPM 60b. A first sensor 151b is disposed along the first document track portion 101b just before the MICR head 72b. A second sensor 152b is disposed along the first document track portion 101b just after the endorser printer 78b.

It should be apparent that the CPM 60b of FIG. 4 is shown in a third configuration where a pocket module (designated with reference numeral “80b” in FIG. 4) is located in a lower or bottom portion of the CPM. Accordingly, components of the CPM 60b of FIG. 4 are configured in a third mode of operation to provide functionality of the Model CPM3 check processing module sold by NCR Corporation.

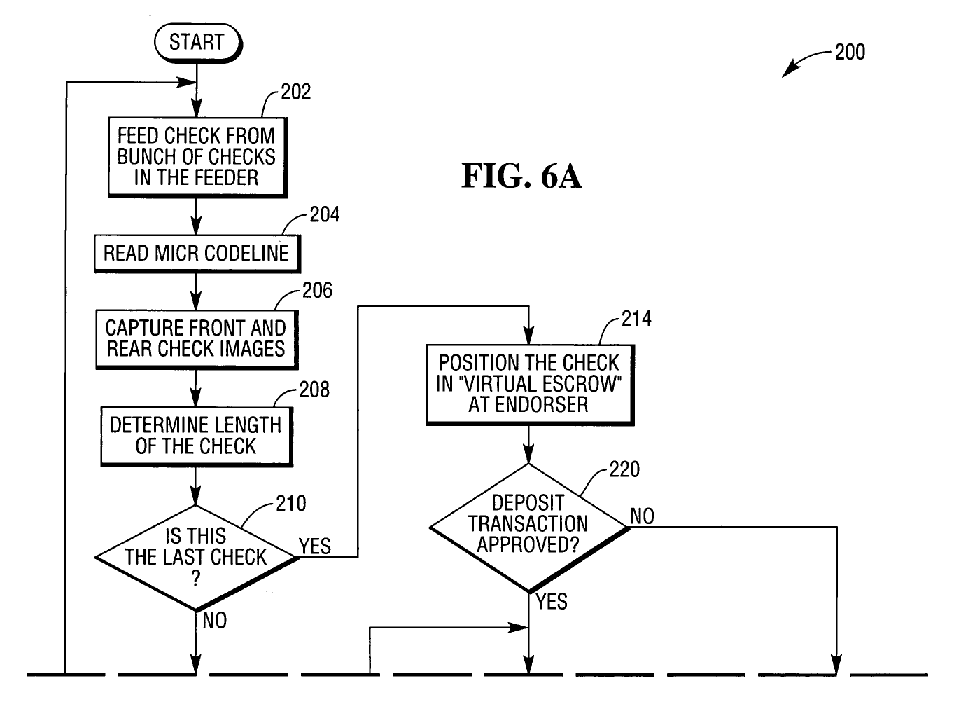

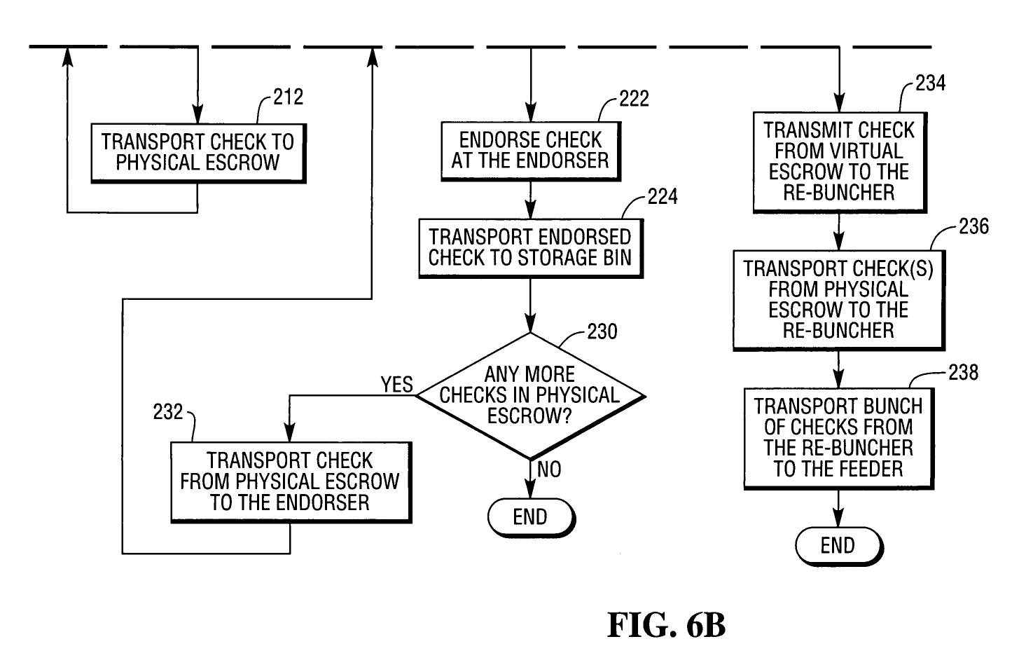

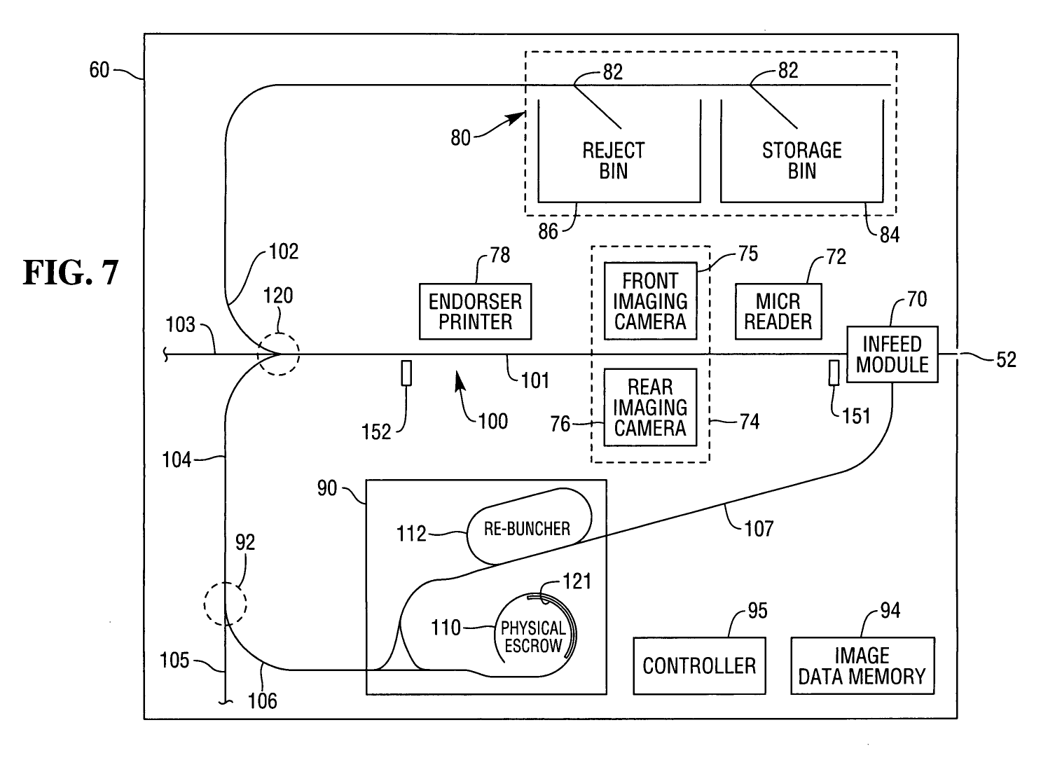

Referring to FIG. 6, is a flowchart depicts operation of the CPM 60 of FIG. 2 in accordance with one embodiment of the present invention. For simplicity, a number of typical steps which precede step 202 of FIG. 6 are not shown. These typical steps include, for example, the ATM customer inserting an ATM card, and the ATM customer entering a PIN number to gain access to the CPM 60 to conduct a bunch-check check deposit transaction at the ATM. For purpose of describing the flowchart of FIG. 6, reference will be made to FIG. 7 which is similar to FIG. 2 and which shows additional details of the ERBM 90.

As shown in step 202 of FIG. 6, after the ATM customer has placed a bunch of checks into a feeder (not shown) of the infeed module 70 shown in FIG. 7, a first check from the bunch is fed along the first track portion 101. For simplicity, while the number of checks in the bunch of checks could be any number of checks, it will be assumed that there are only two checks (i.e., a first check and a second check) in the bunch of checks. The first check is transported past the MICR head 72 to allow the MICR head to read a codeline from the first check (step 204). The front and rear imaging cameras 74, 75 capture an image of the front and rear of the first check and store the captured check images in the image data memory 94 (step 206). As the first check is being transported along the first track portion 101 past the MICR head 72 and the front and rear imaging cameras 74, 75, the first sensor 151 detects the leading edge of the first check and the trailing edge of the first check and provides first sensor signals in response thereto. The first sensor signals from the first sensor 151 are processed to provide a first output signal which is indicative of the length of the first check which is being fed along the first track portion 101 (step 208).

A determination is made in step 210 as to whether the first check is the last check of the bunch of checks. Since the second check is still in the feeder of the infeed module 70 in this example scenario, the determination in step 210 is negative. The first check is then transported through the first diverter 120, along the fourth track portion 104, through the second diverter 92, and then along the sixth track portion 106 into a physical escrow 110 of the ERBM 90 (step 212). As shown in FIG. 7, the first check is designated with reference number 121 and is shown in the physical escrow 110. The process then loops back to step 202 and continues to process the next check (i.e., the second check in this example scenario) in the same manner as that just described hereinabove in steps 202, 204, 206, and 208 for the first check 121 which is now in the physical escrow 110.

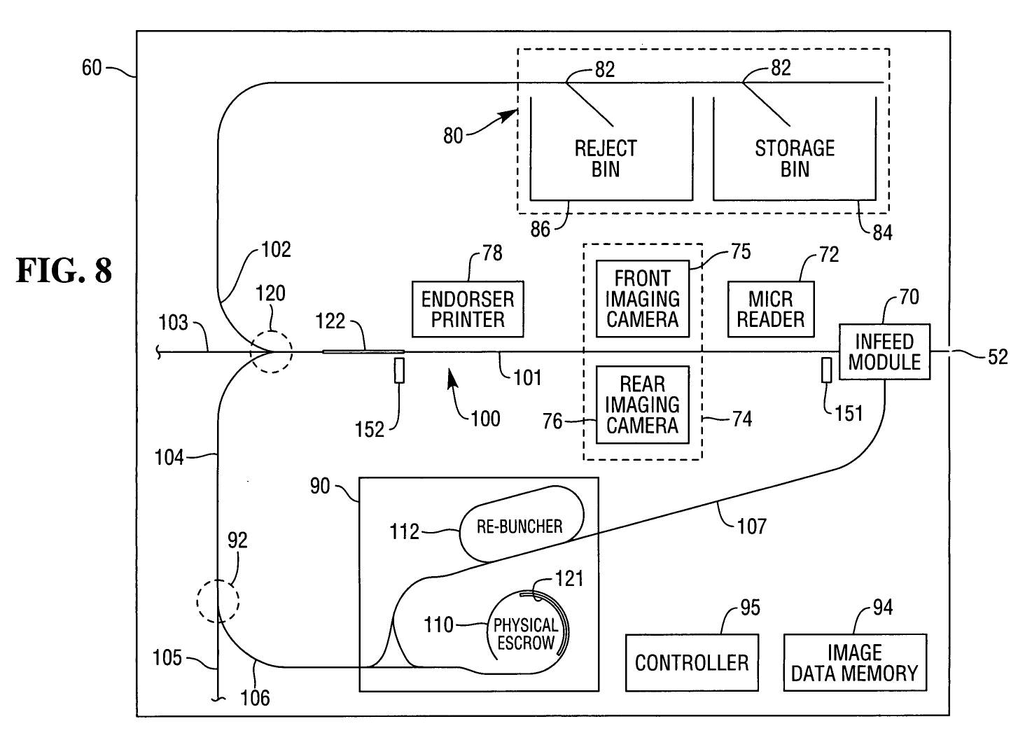

After the length of the second check is determined in step 208, the process proceeds to step 210 in which a determination is made as to whether the second check is the last check. Since there are no other checks in this example scenario, the determination in step 210 is affirmative, and the process proceeds to step 214. In step 214, the second check is positioned and halted along the first track portion 101 in a “virtual escrow” position just past the endorser printer 78. As shown in FIG. 8, the second check is designated with reference number 122 and is shown in the virtual escrow position along the first track portion 101 just past the endorser printer 78.

A determination is then made in step 220 as to whether the present bunch-check deposit transaction is approved. This determination is made while the first check 121 is held in physical escrow 110 and the second check 122 is held in virtual escrow as shown in FIG. 8. If the determination in step 220 is negative (i.e., the present bunch-check deposit transaction is not approved), then the process proceeds to step 234. As a result of the bunch-check deposit transaction being not approved, the second check 122 held in virtual escrow is transported along the fourth and sixth track portions 104, 106 into a re-buncher 112 of the ERBM 90 (step 234). The first check 121 held in physical escrow 110 is then transported to the re-buncher 112 (step 236). The bunch of checks (i.e., the first and second checks 121, 122 in this example scenario) is then transported from the re-buncher 112 along the seventh track portion 107 to return the bunch to the ATM customer, and the process ends.

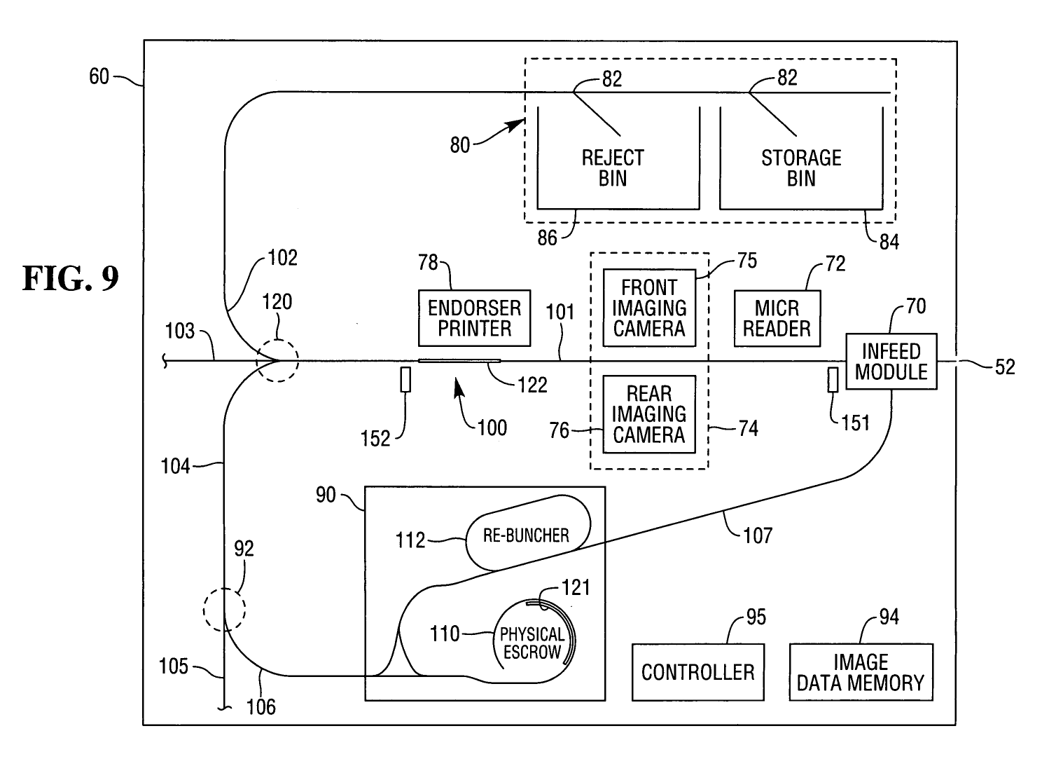

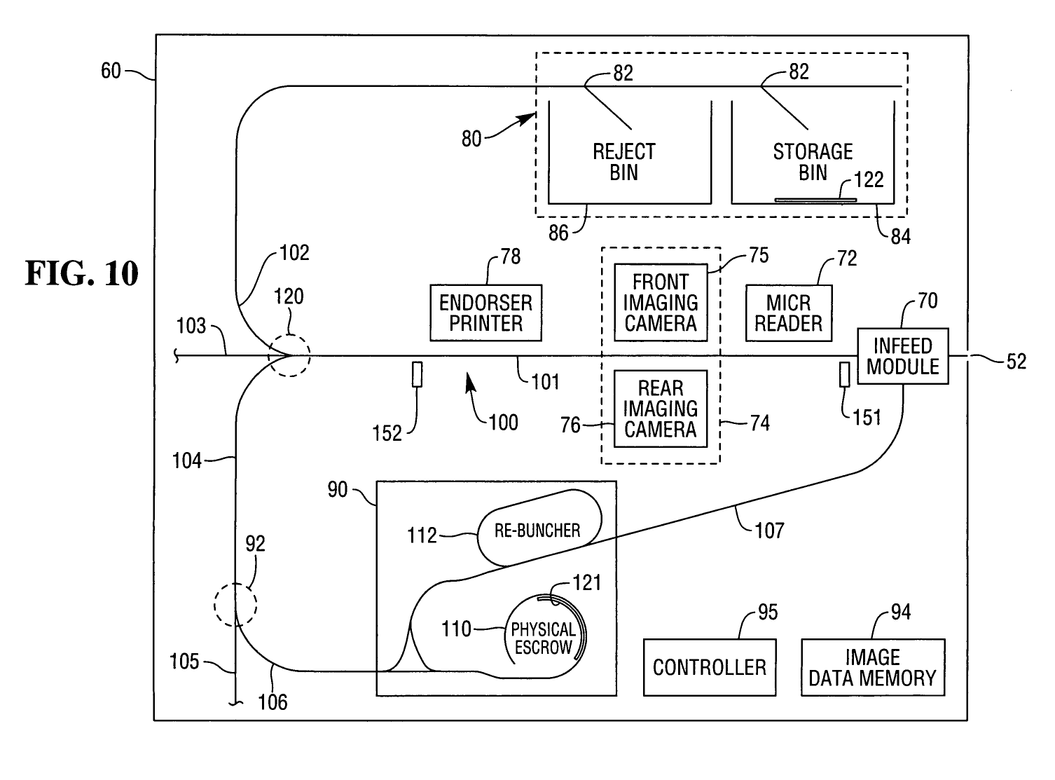

However, if the determination made in step 220 is negative (i.e., the present bunch-check deposit transaction is approved), then the process proceeds to step 222. In step 222, the second check 122 is transported in a reverse direction along the first track portion 101 to a position as shown in FIG. 9 to allow the endorser printer 78 to endorse the second check. The second sensor 152 detects the leading edge of the second check 122 and the trailing edge of the second check and provides second sensor signals in response thereto. The second sensor signals from the second sensor 152 and the first output signal from the first sensor 151 are used together and processed to properly position the second check 122 along the first track portion 101 in the position shown in FIG. 9. The endorsed second check 122 is then transported in the forward direction along the first track portion 101, through the first diverter 120, and along the second track portion 102 to the storage bin 84, as shown in FIG. 10.

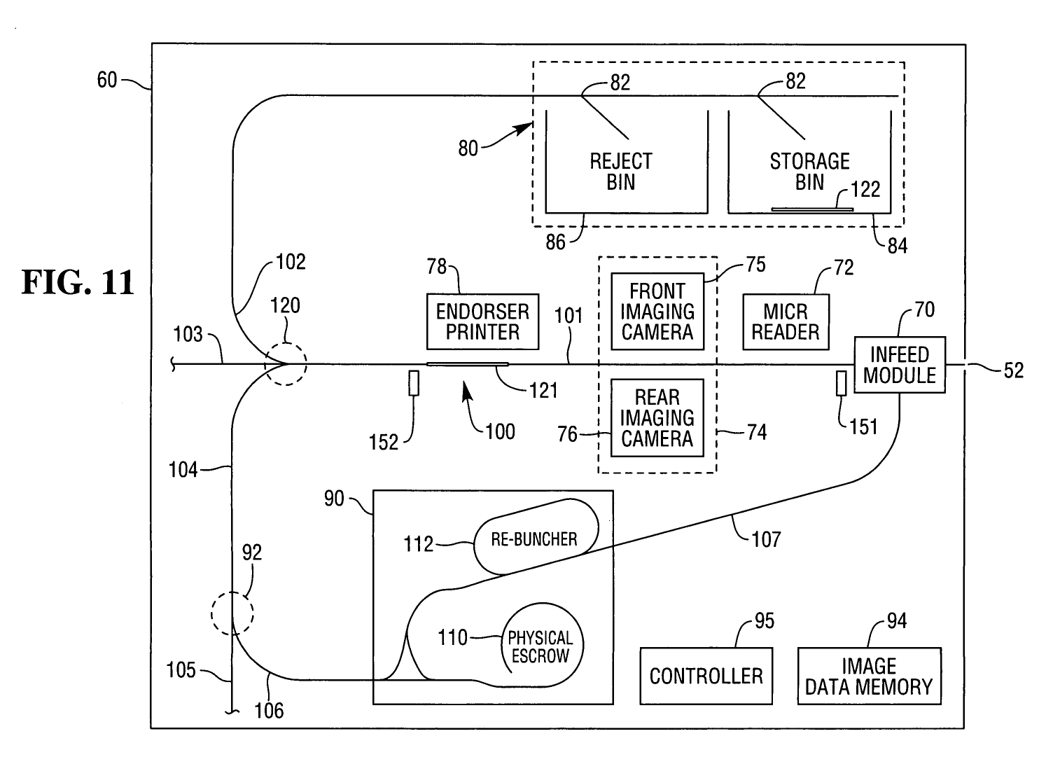

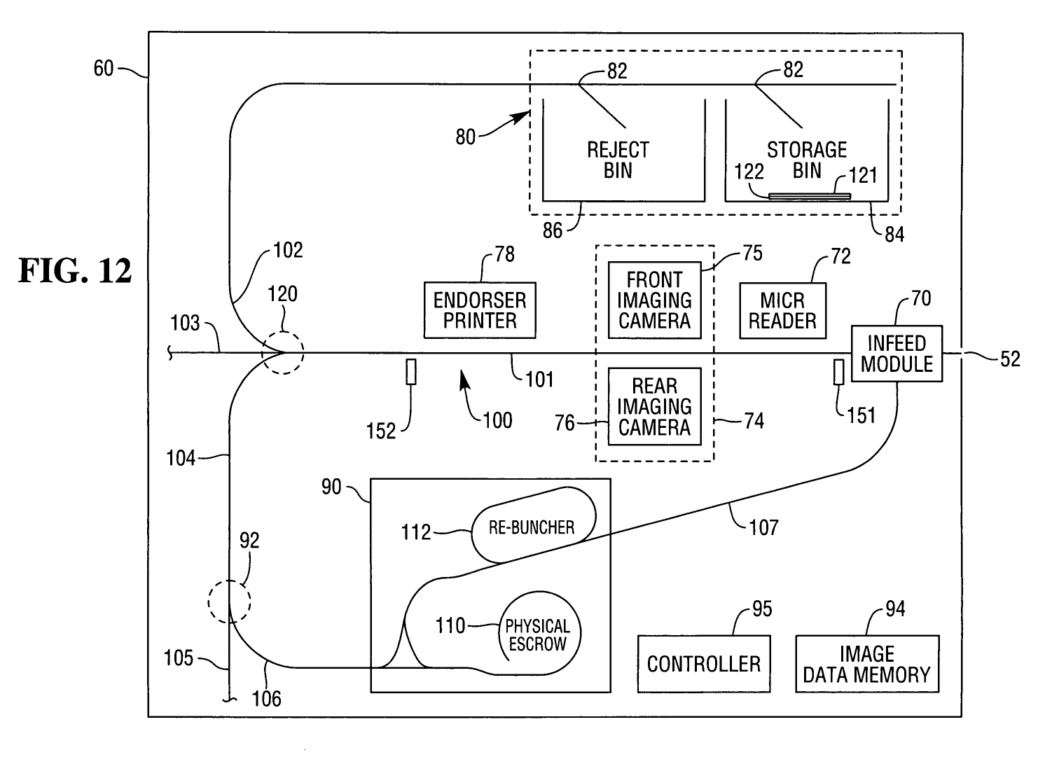

The process then proceeds to step 230 in which a determination is made as to whether there are any other checks in physical escrow 110. Since the first check 121 is in the physical escrow 110 in this example scenario, the determination in step 230 is affirmative. The first check 121 in physical escrow 110 is then transported along the sixth, fourth, and first track portions 106, 104, 101 to a position as shown in FIG. 11 to allow the endorser printer 78 to endorse the first check (step 222). The endorsed first check 121 is then transported along the first and second track portions 101, 102 to the storage bin 84, as shown in FIG. 12. Another determination is then made in step 230 as to whether another check is in physical escrow 110. In this example scenario, there are no other checks and the process ends.

Although the above description describes a check bunch which contains only two checks, it conceivable that any number of checks greater than two checks be processed in the same manner as described. The last check of the bunch is held in the virtual escrow position and all other checks of the bunch are held in the physical escrow 110. The last check is the first one to be endorsed and transported to the storage bin 84, and then the remaining checks are transported one-by-one to the endorser printer 78 to be endorsed before being transported to the storage bin 84.

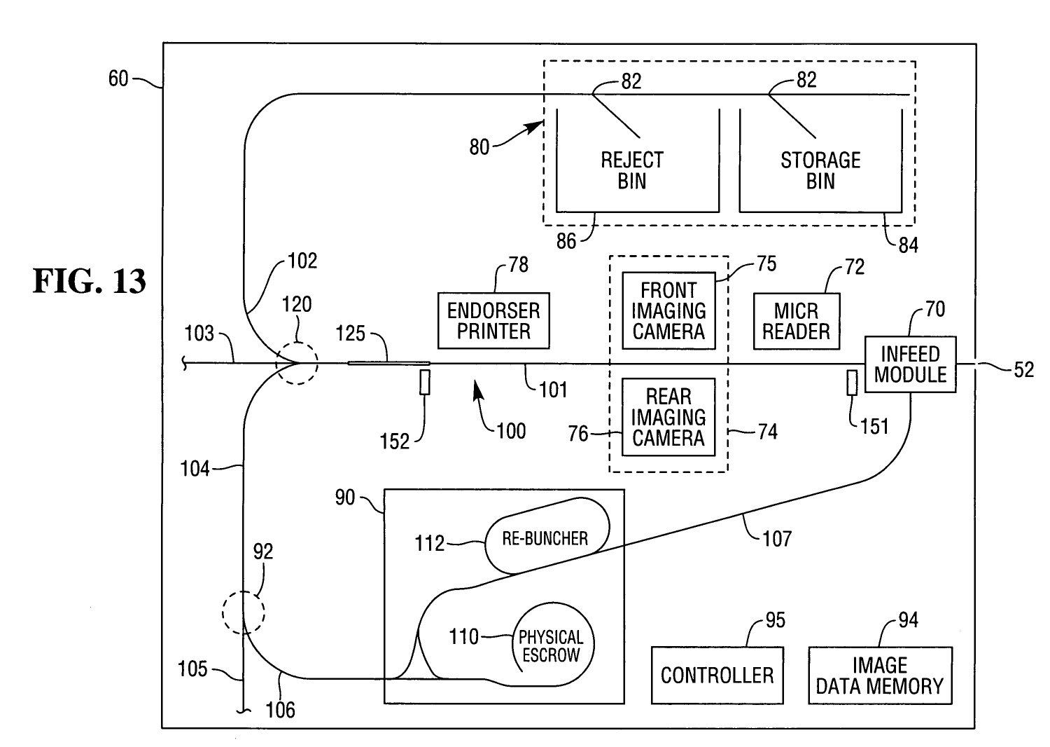

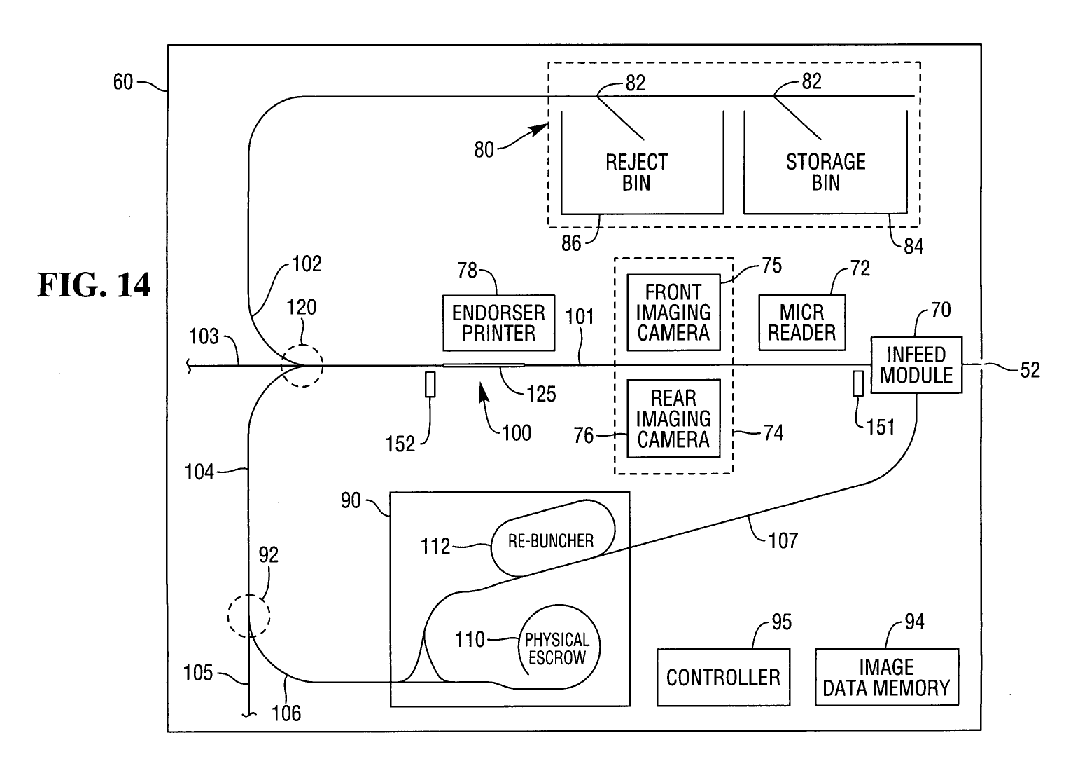

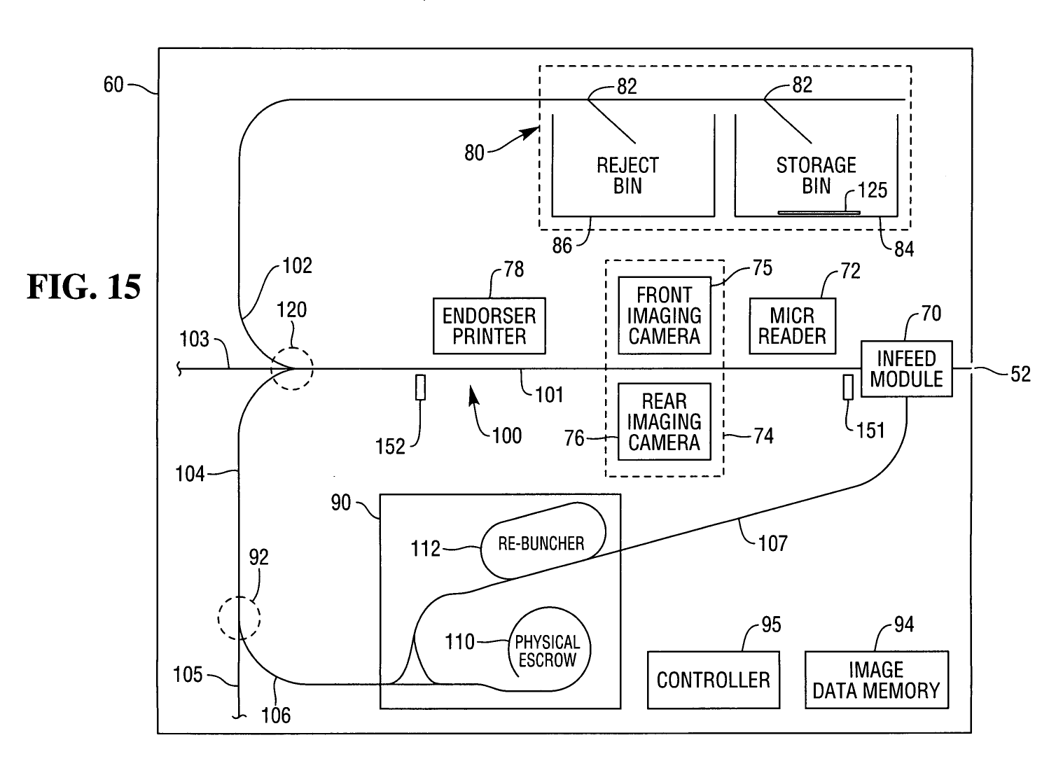

Also, although the above description describes two or more checks being processed, it is conceivable that only a single check (i.e., a bunch containing only one check) can be processed in accordance with the flowchart of FIG. 6. In this case, the single check (which is designated with reference numeral 125 and shown in FIG. 13) is transported to the virtual escrow position (as shown in FIG. 13) and held in that position while the check deposit transaction is being approved. The single check 125 is at no time transported to the physical escrow 110. After the check deposit transaction is approved, the single check 125 is backed up along the first track portion 101 to the endorser printer 78 to be endorsed, as shown in FIG. 14. The endorsed single check 125 is then transported along the first and second track portions 101, 102 to the storage bin 84, as shown in FIG. 15.

It should be apparent that the last check processed is stopped along the first track portion 101 as soon as all processing operations (except the endorsing operation) are completed. The stopped position of the last check along the first track portion 101 becomes the virtual escrow position at which the last check is staged. The last check in the virtual escrow position is treated the same way as it would have been treated had it been transported to the physical escrow 110. Since the last check is not transported to the physical escrow 110, the overall time needed for the check depositing transaction is reduced. The reduction in the overall time needed for the check depositing transaction is especially significant for a relatively smaller bunch of checks such as two checks or just a single check.

Also, since the last check is not transported to the physical escrow 110, it should be apparent that the distance the last check travels within the CPM 60 is reduced. The reduction of the travel distance of the last check reduces the risk of the last check jamming along a track portion of the CPM 60. The reduction of the risk of the last check jamming is especially significant for a relatively smaller bunch of checks such as two checks or just a single check. Accordingly, overall reliability of the CPM 60 is improved.

Although the above description describes the PERSONAS (trademark) 6676 NCR ATM embodying the present invention, it is conceivable that other models of ATMs, other types of ATMs, or other types of self-service check depositing terminals may embody the present invention. Self-service depositing terminals are generally public-access devices that are designed to allow a user to conduct a check deposit transaction in an unassisted manner and/or in an unattended environment. Self-service check depositing terminals typically include some form of tamper resistance so that they are inherently resilient.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A method of processing a last check of a bunch of checks deposited at the self-service terminal during a bunch-check deposit transaction, the method comprising:
receiving the last check along a check transport path;
processing the last check as the last check is being transported along the check transport path;
transporting the processed check to a virtual escrow which is along a portion of the check transport path and which is other than a physical escrow;
approving the bunch-check deposit transaction as the last check is being held in the virtual escrow;
after the bunch-check deposit transaction is approved, transporting the last check from the virtual escrow to an endorser to allow the endorser to endorse the last check;
endorsing the last check; and
after the last check is endorsed, transporting the endorsed check to a storage bin.

2. A method according to claim 1, wherein the last check is the first and only check of the bunch of checks being deposited during the bunch-check deposit transaction.

3. A method according to claim 1, wherein the virtual escrow is adjacent to the endorser.

4. A method according to claim 1, wherein processing includes either reading a magnetic ink character recognition (MICR) codeline from the last check or capturing an image of the last check, or both.

5. A method of processing a single check deposited at a self-service terminal having a physical escrow, the method comprising:
receiving the check along a check transport path;
processing the check as the check is being transported along the check transport path;
transporting the processed check to a virtual escrow which is along a portion of the check transport path and which is other than the physical escrow;
approving the check deposit transaction as the check is being held in the virtual escrow;
after the check deposit transaction is approved, transporting the check from the virtual escrow to an endorser to allow the endorser to endorse the check;
endorsing the check; and
after the check is endorsed, transporting the endorsed check to a storage bin.

6. A method according to claim 5, wherein the virtual escrow is adjacent to the endorser.

7. A method according to claim 5, wherein processing includes either reading a magnetic ink character recognition (MICR) codeline from the check or capturing an image of the check, or both.

8. A method of operating a check processing module (CPM) for a self-service check depositing terminal to process checks deposited at the self-service terminal during a bunch-check deposit transaction, the method comprising:
receiving a first check along a check transport path;
processing the first check as the first check is being transported along the check transport path;
transporting the processed first check to a physical escrow;
receiving a second check along the check transport path;
processing the second check as the second check is being transported along the check transport path;
transporting the processed second check to a virtual escrow which is other than a physical escrow; and
approving the bunch-check deposit transaction as the first processed check is being held in the physical escrow and the second processed check is being held in the virtual escrow which is other than a physical escrow.

9. A method according to claim 8, further comprising:
after the bunch-check deposit transaction is approved, transporting the first check from the virtual escrow to an endorser to allow the endorser to endorse the first check;
endorsing the first check; and
after the first check is endorsed, transporting the endorsed first check to a storage bin.

10. A method according to claim 9, further comprising:
after the endorsed first check is transported to the storage bin, transporting the second check from the physical escrow to the endorser to allow the endorser to endorse the second check;
endorsing the second check; and
after the second check is endorsed, transporting the endorsed second check to the storage bin.

11. A method according to claim 8, wherein the virtual escrow is along a portion of the check transport path.

12. A method according to claim 11, wherein the virtual escrow is adjacent to the endorser.
